(19) United States
(12) Patent Application Publication
(10) Pub. No.: US 2014/0360063 A1
(43) Pub. Date: Dec. 11, 2014

(54) Advertising Calendar

(71) Applicant: Ying-Hsuan Chiu, New Taipei City (TW)

(72) Inventor: Ying-Hsuan Chiu, New Taipei City (TW)

(21) Appl. No.: 14/294,496

(22) Filed: Jun. 3, 2014

(30) Foreign Application Priority Data
Jun. 6, 2013 (TW) 102210623 U

(51) Int. Cl. B42D 5/04; B42D 5/06; G09F 23/10

(52) U.S. Cl. CPC B42D 5/047; G09F 23/10; B42D 5/06
USPC 40/107

(57) ABSTRACT

An advertisement calendar includes a hanging mechanism and a plurality of calendar pages. Each calendar page includes a date indicating portion, an information publishing portion, and an advertisement portion. An object can be be attached to the advertisement portion.

### BACKGROUND OF THE INVENTION

The present invention relates to an advertising calendar and, more particularly, to an advertising calendar to which objects can be removably attached, providing an advertisement effect.

An ordinary calendar includes a plurality of pages in which outdated pages can be torn off daily or monthly to reveal the page of the current date or month. In addition to the information of date, week, or a daily information of the date in the case of a Chinese lunar calendar, conventional calendar pages generally include photographs of scenes and advertisement sections showing advertisement of some companies or units. However, the calendars become less and less important in offices or homes and are gradually replaced due to the monotonous design.

### BRIEF SUMMARY OF THE INVENTION

An advertisement calendar includes a hanging mechanism and a plurality of calendar pages. Each of the plurality of calendar pages includes a date indicating portion, an information publishing portion, and an advertisement portion. An object is adapted to be attached to the advertisement portion.

In an example, the hanging mechanism includes a fixing portion. The fixing portion can be a hook, a hanger hole, or a magnetic element.

In an example, the advertisement portion includes an attachment portion. The object is adapted to be re-adherably attached to the attachment portion. The object can be a sticky note, a business card, a photograph, or a piece of paper with information.

In another example, the advertisement portion includes a tearable portion having a plurality of strips tearable from the advertising calendar. Each of the plurality of strips is a coupon or a value ticket.

The present invention will become clearer in light of the following detailed description of illustrative embodiments of this invention described in connection with the drawings.

### DESCRIPTION OF THE DRAWINGS

FIG. 1 is a schematic view of an advertising calendar of an embodiment according to the present invention.

FIG. 2 is a portion of the advertising calendar of the embodiment according to the present invention.

FIG. 3 is a portion of an advertising calendar of another embodiment according to the present invention.

### DETAILED DESCRIPTION OF THE INVENTION

To provide a calendar with a better advertising effect, an advertising calendar according to the present invention includes an advertisement portion allowing a user to selectively publish information (such as advertisement, scene information, living stories, or missing people posters) on the advertisement portion. The information can be randomly and individually published on the advertisement portion.

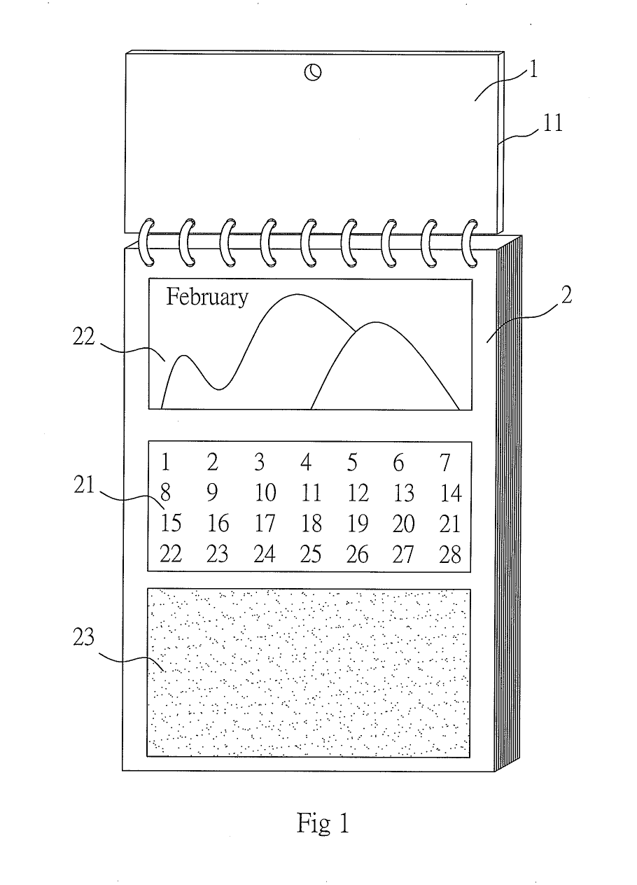

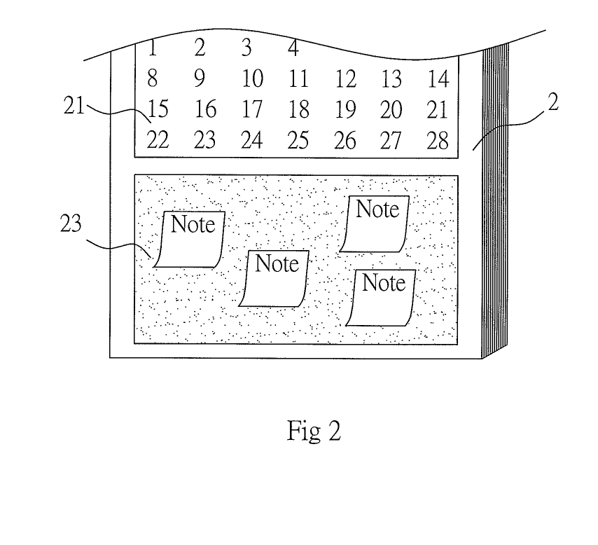

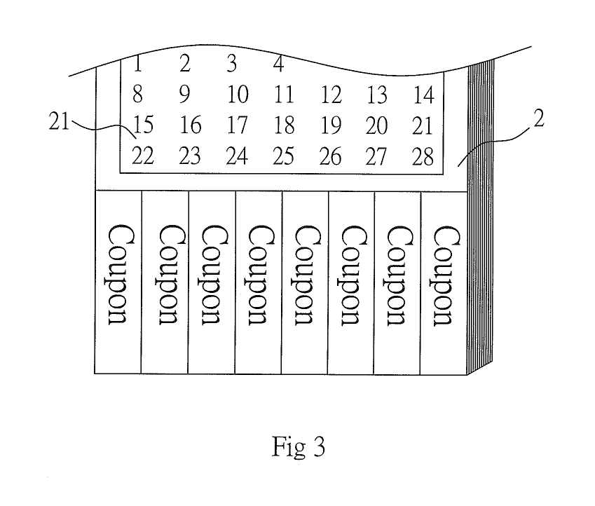

With reference to FIGS. 1-3, an advertising calendar according to the present invention includes a hanging mechanism 1 and a plurality of calendar pages 2. The main features of the present invention are that each calendar page 2 includes a date indicating portion 21, an information publishing portion 22, and an advertisement portion 23.

The hanging mechanism 1 includes a fixing portion 11. The fixing portion 11 can be, but is not limited to, a hook, a hanger hole, or a magnetic element. The advertising calendar can be fixed to a working site or in a space of a public transportation vehicle by the fixing portion 11, allowing people to read the information.

The date indicating portion 21 shows the information of date, week, or a daily information of the date in the case of a Chinese lunar calendar.

The information publishing portion 22 shows information to be passed on by the publisher to the user or the viewer, such as governmental publicity or advertisement by a for-profit business unit, providing sufficient information and, thus, increasing utility of the advertising calendar.

The advertisement portion 23 includes an attachment portion 231. One or more objects can be attached to the attachment portion 231. The objects can be re-adherably attached to the attachment portion 231. Each object can be a sticky note, a business card, a photograph, or a piece of paper with information, which can be useful in cooperation with the date information to arrange information and to disseminate the correct information.

The advertisement portion 23 can include a tearable portion 232 having a plurality of strips 2321 tearable from the advertising calendar. Each strip 2321 can be a coupon or a value ticket. The user can receive instant information in time after each outdated calendar page 2 is torn off. Thus, the user will not miss any useful information.

Although specific embodiments have been illustrated and described, numerous modifications and variations are still possible without departing from the scope of the invention. The scope of the invention is limited by the accompanying claims.

1. An advertising calendar comprising a hanging mechanism and a plurality of calendar pages, with each of the plurality of calendar pages including a date indicating portion, an information publishing portion, and an advertisement portion, and with an object adapted to be attached to the advertisement portion.

2. The advertising calendar as claimed in claim 1, with the hanging mechanism including a fixing portion, and with the fixing portion being a hook, a hanger hole, or a magnetic element.

3. The advertising calendar as claimed in claim 1, with the advertisement portion including an attachment portion, with the object adapted to be re-adherably attached to the attachment portion, and with the object being a sticky note, a business card, a photograph, or a piece of paper with information.

4. The advertising calendar as claimed in claim 1, with the advertisement portion including a tearable portion, with the tearable portion including a plurality of strips tearable from the advertising calendar, and with each of the plurality of strips being a coupon or a value ticket.
